(19) United States
(12) Patent Application Publication
(10) Pub. No.: US 2003/0122278 A1
(43) Pub. Date: Jul. 3, 2003

(54) Method for applying multiple decorative-functional films to injection mold components

(76) Inventor: Peter Kosanvoich, Algonquin, IL (US)

Correspondence Address: MOTOROLA INC, 600 NORTH US HIGHWAY 45, LIBERTYVILLE, IL, 60048-5343, US

(21) Appl. No.: 10/035,072

(22) Filed: Dec. 28, 2001

(51) Int. Cl. B29C 45/16

(52) U.S. Cl. 264/247; 264/255

(57) ABSTRACT

A method for applying multiple decorative sheets of film to an injection-mold component as a part of the injection mold process is described. Two sheets of film (202, 204) having desired images (206, 208) are permanently affixed to the surfaces (604, 606) of the injection mold component (602) as a part of the injection molding process. An enhanced three-dimensional appearance is achieved by affixing the images to a transparent injection mold component.

### FIELD OF THE INVENTION

This invention relates generally to an injection molding method for applying printed material onto injection mold components and, more specifically, to multiple sheets of film having printed material that are applied to injection mold components during an injection molding process.

### BACKGROUND OF THE INVENTION

Images are often have printed on or applied to surfaces of products for several reasons, such as to identify a product and/or its manufacturer, to differentiate the product among a family of similar products, or to enhance the appearance of the product. For example, a lens covering the display area of a radiotelephone may incorporate a model number, a manufacturer name and a logo. Images printed onto irregular surfaces of small consumer products are often expensive and easily damaged. The lens typically has a curved surface and often comes in contact with other objects, such as a user's finger. Alternatively, images are printed onto a sheet of film, and this sheet of film is then applied and secured to the surface of the lens. For a trasparent device such as a lens covering a display and having front and back surfaces, a combination of both methods has been utilized: a sheet of film having printed images is applied to one surface, and images are printed on the other surface. However, this combination method is a multiple-step process comprising production of the lens, application of a sheet of film having printed images on one surface, and printing of graphics on the other surface. Accordingly, there is a need for a method to reduce process steps and cost for enhancing, and differentiating the appearance of an injection mold component.

### BRIEF DESCRIPTION OF THE DRAWINGS

FIG. 1 illustrates a perspective view of injection molds that may be adapted to form an injection mold component in accordance with the preferred embodiment of the present invention;

FIG. 2 illustrates frontal views of sheets of film having images to be applied to the injection mold component in accordance with the preferred embodiment of the present invention;

FIG. 3 illustrates side views of sheets of film of FIG. 2 showing layering of the sheets;

FIG. 4 illustrates a sectional view of the injection molds of FIG. 1 and the sheets of film of FIG. 2;

FIG. 5 illustrates a sectional view of the injection molds, with the sheets of film of FIG. 2 placed to form an injection mold component shape;

FIG. 6 illustrates a sectional view of the injection molds and sheets of film of FIG. 5 with a resin injected into the injection mold component shape; and,

FIG. 7 is a skeletal, perspective view of an injection mold component formed by the molds and having both sheets of film with images adhered to both sides.

### SUMMARY OF THE INVENTION

The present invention is a method for applying images to an injection mold component. Two sheets of film having desired images are placed in the mold for the injection mold component. A resin is injected into the mold filling the mold and forming the injection mold component. One surface of the injection mold component directly contacts the first sheet of film, and another surface of the component directly contacts the second sheet of film. As the injection mold component is allowed to solidify, the first and the second sheets of film are permanently affixed to the surfaces of the injection mold component without changing the images. The component is then removed from the mold. For a transparent injection mold component, a three-dimensional appearance of the images is enhanced.

### DETAILED DESCRIPTION OF A PREFERRED EMBODIMENT

The present invention describes a method for applying multiple decorative sheets of film to an injection-mold component as a part of the injection mold process.

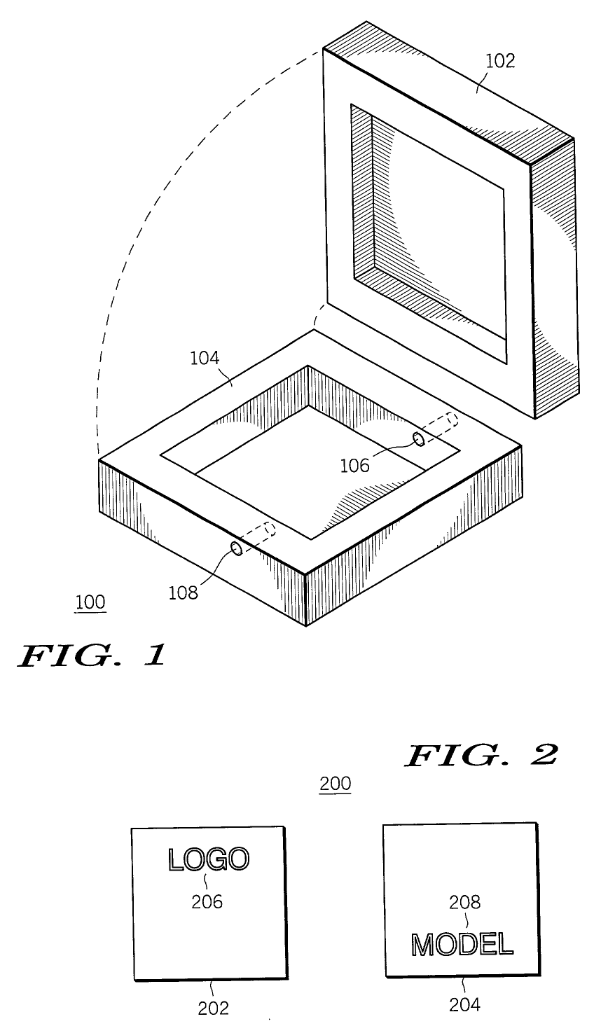

FIG. 1 illustrates first and second molds (102 and 104, respectively) that may be used to form an injection mold component in the preferred embodiment. The second mold contains a resin injection passage (106) and a venting passage (108).

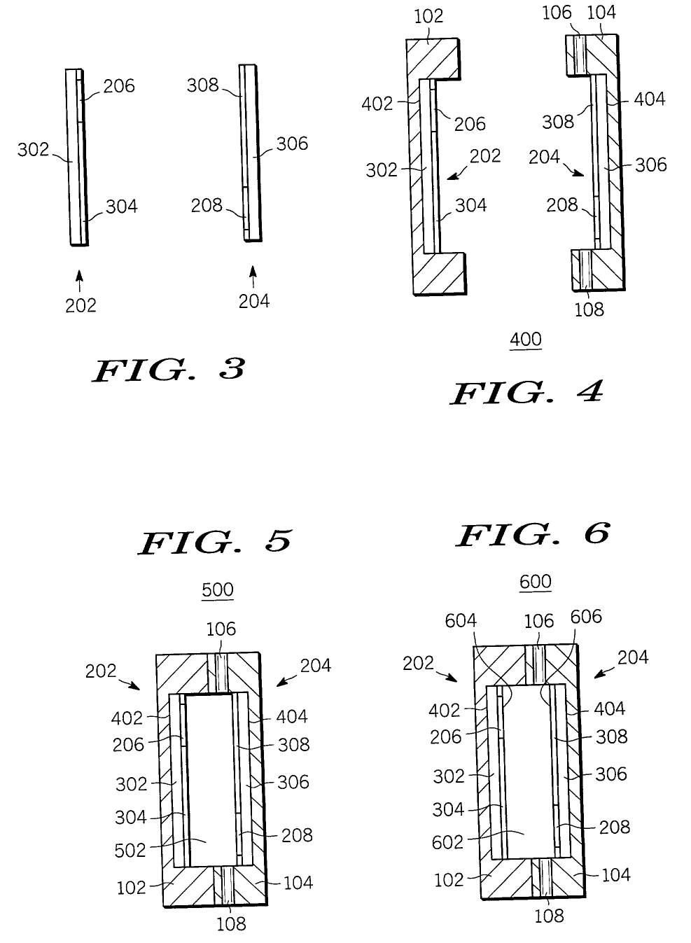

FIG. 2 illustrates the first and the second sheets of film (202 and 204, respectively), having the first and second desired images respectively (206 and 208, respectively), to be applied to the injection mold component of the preferred embodiment. Each sheet of film is substantially the same size as the surface of the injection mold component it is to be applied. Each sheet comprises a film layer, preferably made of polycarbonate material, and an ink layer which contains the images printed on the sheet. FIG. 3 illustrates the side views of the first sheet of film (202) comprising the first film layer (302) and the first ink layer (304) containing the first image (206), and the second sheet of film (204) comprising the second film layer (306) and the second ink layer (308) containing the second image (208). A third ink layer containing a third image may be formed on the surface of the second sheet of film (204) opposite to the second ink layer (308).

The first sheet of film (202) is placed in the first mold (102) on the first mold surface (402), and similarly, the second sheet of film (204) is placed in the second mold (104) on the second mold surface (404) as illustrated in FIG. 4. These sheets of film may be placed in the molds robotically, and may be held in place by using vacuum.

The first (102) and the second (104) molds, facing each other, are brought together to form the component mold (502) shaped by the first mold surface (402) and the second mold surface (404), which is in the shape of the desired injection mold component as illustrated in FIG. 5.

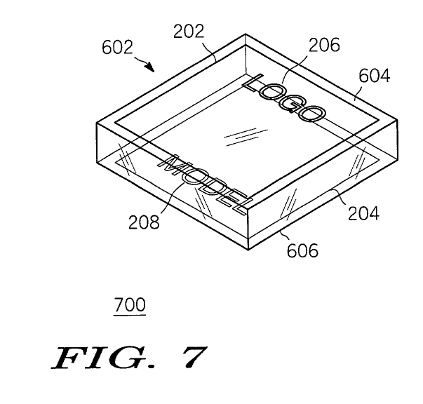

Once the component mold (502) is formed, a resin, preferably a polycarbonate resin, is injected into the component mold through the resin injection passage (106), and air is forced out of the component mold through the venting passage (108). These passages may be located anywhere in the mold provided that a resin can be injected into the mold without interfering with sheets of film to be applied. As the resin substantially occupies the component mold (502) forming the injection mold component (602), the first surface (604) of the injection mold component directly contacts the first sheet of film (202) as illustrated in FIG. 6. Similarly, the second surface (606) of the injection mold component (602) directly contacts the second sheet of film (204). The injection mold component (602) is then allowed to solidify. As it solidifies, the first (202) and second (204) sheets of film adhere to the first and the second surfaces (604, 606) of the injection mold component (602) permanently without changing the appearance of the images (206, 208) on the first and second sheets of film (202, 204). The injection mold component is then removed from the component mold (502) by separating first and second molds (102, 104).

By combining the molding step to produce an injection mold component and affixing images to the injection mold component step, this method reduces required steps to produce a finished injection mold component having images. In addition to being able to affix multiple desired images onto an injection mold component, this process achieves an enhanced three-dimensional appearance of the images for a transparent component. FIG. 7 illustrates a transparent finished injection mold component (602) having the first and second sheets of film (202, 204) permanently affixed to the first and second component surfaces (604, 606). By offsetting the second image (208) relative to the first image (206), depth perception, or a three-dimensional appearance, of the second image through the transparent injection mold component is enhanced. This method further provides an advantage of protecting the images by placing a protection layer, the non-image side of the sheet of film facing outward, over the images.

While the preferred embodiment of the invention suitable for a display cover such as a lens has been illustrated and described, it is to be understood that the invention is not so limited. Different material, such as acrylic and polyester, may be used as a resin and film. Images may also be printed using luminescent ink to improve display lighting. Numerous modifications, changes, variations, substitutions and equivalents will occur to those skilled in the art without departing from the broad scope of the present invention as defined by the appended claims.

What is claimed is:

1. A method for applying images to an injection mold component, the method comprising steps of:
providing a first and a second molds, the first mold having a first mold surface and the second mold having a second mold surface, the second mold surface facing the first mold surface;
placing a first sheet of film on the first mold surface and a second sheet of film on the second mold surface, the first sheet having a first desired image and the second sheet having a second desired image;
bringing together the first mold and the second mold a predetermined distance from each other, the first and second mold surfaces forming a component mold in a shape of the injection mold component; and,
injecting a resin into the component mold, the resin substantially filling the component mold forming the injection mold component, the injection mold component having a first component surface directly contacting the first sheet of film and a second component surface substantially opposite the first component surface directly contacting the second sheet of film.

2. The method of claim 1 further comprising the step of allowing the injection mold component to substantially solidify.

3. The method of claim 1 further comprising the step of removing the injection mold component from the component mold by separating the first mold from the second mold.

4. The method of claim 1 wherein the first sheet of film having the first image is permanently affixed on the first component surface of the injection mold component and the second sheet of film having the second image is permanently affixed on the second component surface of the injection mold component.

5. The method of claim 1 wherein the first and second images appear unchanged before and after coming into a contact with the resin.

6. A method for applying images to an injection mold component for enhancing an appearance of a three dimensional image, the method comprising steps of:
providing a first and a second molds, the first mold having a first mold surface and the second mold having a second mold surface, the second mold surface facing the first mold surface;
placing a first sheet of film on the first mold surface and a second sheet of film on the second mold surface, the first sheet having a first desired image and the second sheet having a second desired image;
bringing together the first mold and the second mold a predetermined distance from each other, the first and second mold surfaces forming a component mold in a shape of the injection mold component; and,
injecting a resin into the component mold, the resin substantially filling the component mold forming the injection mold component, the injection mold component having a first component surface directly contacting the first sheet of film and a second component surface substantially opposite the first component surface directly contacting the second sheet of film, wherein the injection mold component is transparent.

7. The method of claim 6 further comprising the step of allowing the injection mold component to substantially solidify.

8. The method of claim 6 further comprising the step of removing the injection mold component from the component mold by separating the first mold from the second mold.

9. The method of claim 6 wherein the first sheet of film having the first image is permanently affixed on the first component surface of the injection mold component and the second sheet of film having the second image is permanently affixed on the second component surface of the injection mold component.

10. The method of claim 6 wherein the first and second images appear unchanged before and after coming into a contact with the resin.

11. The method of claim 6 wherein the injection molding component is assembled into a radiotelephone.
